(19) United States
(12) Patent Application Publication
(10) Pub. No.: US 2007/0250792 A1
(43) Pub. Date: Oct. 25, 2007

(54) PRESENTATION OF SERVICE DATA IN SUPPORT OF A USER INTERACTIVE APPLICATION PROGRAM DURING RUNNING OF THE PROGRAM ON A COMPUTER CONTROLLED DISPLAY

(76) Inventors: Andrew Jason Lavery, Austin, TX (US); Howard Milton McKinney, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/379,832

(22) Filed: Apr. 24, 2006

(51) Int. Cl. G06F 3/048

(52) U.S. Cl. 715/810

(57) ABSTRACT

The display of support service data on application programs being run for the interactive user of a computer controlled display system. The implementation combines offering to a user a plurality of selectable displayed items, each representative of a level of complexity at which service data is to be presented, enabling the user to select one of these complexity levels, displaying user interactive application programs running on the system and presenting service data relative to the program being run, at the selected complexity level. The service data provided comes primarily from the operating system of the computer running the application program or the service data may be provided by running the application program itself.

### TECHNICAL FIELD

The present invention relates to user interactive computer supported display technology and particularly to Graphical User Interfaces (GUIs) that are user-friendly and provide interactive users with an interface environment that is easy to use.

### BACKGROUND OF RELATED ART

The past generation has been marked by a technological revolution driven by the convergence of the data processing industry with the consumer electronics industry. This advance has been even further accelerated by the extensive consumer and business involvement in the Internet or World Wide Web (Web). As a result of these changes, it seems as if virtually all aspects of human endeavor in the industrialized world require human-computer interfaces. These changes have made computer directed activities accessible to a substantial portion of the industrial world's population, which, up to a few years ago, was computer-illiterate, or, at best, computer indifferent.

In order for the vast computer supported industries and market places to continue to thrive, it will be necessary for increasing numbers of workers and consumers who are limited in computer skills to become involved with computer interfaces. However, user interfaces that take into account the levels of skills of the users who may be operating through such interfaces are still quite limited in availability. In computer game technology, there are a number of games in which the user may choose the level of skill at which he wishes to play the particular game, i.e. novice . . . or master level. However, the skill level of such game playing has more to do with hand eye coordination and little or nothing to do with computer knowledge or sophistication as to the internals of the computer program. In other words, the skill level selected is dependent upon the ability to play the particular game involved.

However, with respect to computer services, usually provided by the computer operating system or by the application, there conventionally is little provision made for the knowledge level of the user, as well as the skill level of the user in interacting with the computer itself. Because of limited computer knowledge and skills of a great number of people who must use the computer, there is a need for computer functions that consider the knowledge, as well as the skill level of the users.

### SUMMARY OF THE PRESENT INVENTION

The present invention offers a new implementation for providing support services to the interactive user of a computer controlled display system. The implementation combines means for offering to a user a plurality of selectable displayed items, each representative of a level of complexity at which service data is to be presented, means enabling the user to select one of these complexity levels, means for displaying user interactive application programs running on the system and means for presenting service data, relative to the program being run, at the selected complexity level. Some of the service data provided may come from the operating system of the computer running the application program. However, the service data may be provided by running the application program itself, or even from a program that monitors or manages the application program or operating system.

The complexity levels provided for selection may be the complexity level of the text in which the service data is displayed to the user. The complexity level may also be determined by the technical knowledge or technicality of the user with respect to the computer itself.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of an interactive data processor controlled display system including a central processing unit that is capable of implementing the presentation of service data at a user selected complexity level of the present invention;

FIG. 2 is a diagrammatic view of a display screen illustrating the initial stage of a program being run wherein the interactive user is prompted to select the skill level at which service data is to be presented on the display;

FIG. 3 is the display screen view of FIG. 2 after a user has selected a complexity level, and an error message is being presented at the selected complexity level;

FIG. 4 is the display screen view of FIG. 2 after a user has selected a complexity level different from that selected in FIG. 2, and an error message is being presented at the selected complexity level;

FIG. 5 is a flowchart of the program steps involved in setting up a process of the present invention for presenting service data to an interactive user, during an application program run, at a complexity level selected by the user;

FIG. 6 is a flowchart of the steps involved in an illustrative run of the process set up in FIG. 5.

### DETAILED DESCRIPTION OF THE PREFERRED EMBODIMENT

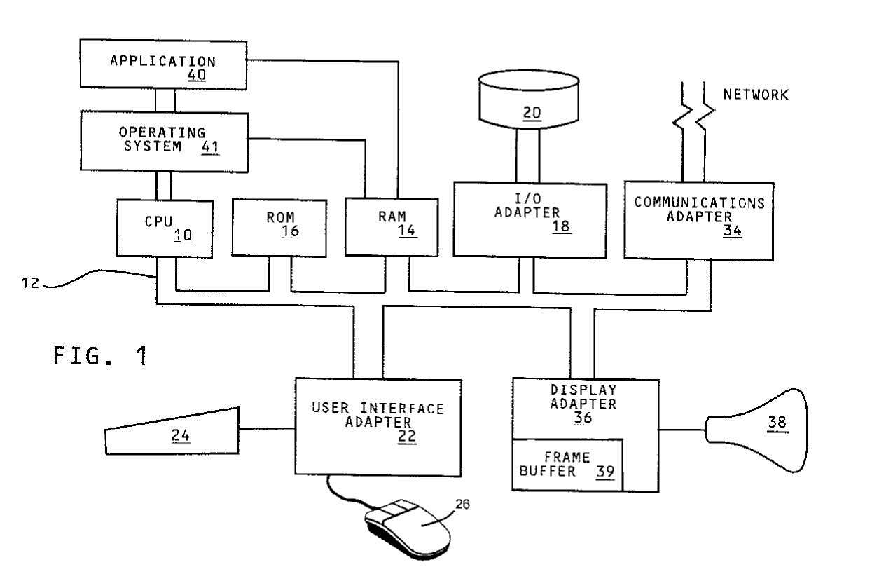

Referring to FIG. 1, a typical data processing system is shown that may function as the computer controlled display terminal used in implementing the system of the present invention to present service data at a user selected complexity level. A central processing unit (CPU) 10, such as any PC microprocessor in a PC available from International Business Machines Corporation (IBM), Lenovo Corporation or Dell Corp., is provided and interconnected to various other components by system bus 12. An operating system 41 runs on CPU 10, provides control and is used to coordinate the function of the various components of FIG. 1. Operating system 41 may be one of the commercially available operating systems such as Microsoft's WindowsXP™ or WindowsNT™, as well as UNIX or IBM's AIX operating systems. Application programs 40 running on the data processing system run in conjunction with operating system 41 and provide output calls to the operating system 41 that in turn implements the various functions to be performed by the application 40. The programs and routines of the present invention for presenting service data at a user selected complexity level, to be subsequently described in greater detail, are part of the operating system. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 communicates with the disk storage device 20, i.e. a hard drive. Communications adapter 34 interconnects bus 12 with an outside network enabling the data processing system to communicate with other such systems over a Local Area Network (LAN) or Wide Area Network (WAN), which includes, of course, the Internet. I/O devices are also connected to system bus 12 via user interface adapter 22 and display adapter 36. Keyboard 24 and mouse 26 are all interconnected to bus 12 through user interface adapter 22. Mouse 26 operates in a conventional manner insofar as user movement is concerned. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned mouse or related devices, a user is capable of inputting information to the system through the keyboard 24 or mouse 26 and receiving output information from the system via display 38.

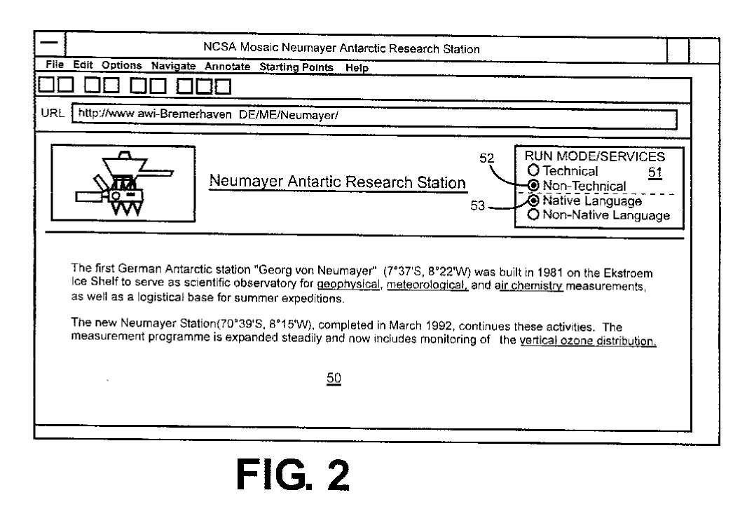

There will now be described a simple illustration of the present invention with respect to the display screens of FIGS. 2 through 4. When the screen images are described, it will be understood that these may be rendered by storing image and text creation programs, such as those in any conventional windows operating system in the RAM 14 of the system of FIG. 1. The operating system is diagrammatically shown in FIG. 1 as operating system 41. The display screens of FIGS. 2 through 4 are presented to the viewer on display monitor 38 of FIG. 1. In accordance with conventional techniques, the user may control the screen interactively through a conventional I/O device, such as mouse 26 of FIG. 1, which operates through user interface 22 to call upon programs in RAM 14 cooperating with the operating system 41 to create the images in frame buffer 39 of display adapter 36 to control the display on monitor 38.

With reference to the display screen of FIG. 2, there is shown a simplified illustration of an initial display screen 50. Let us assume that the user is running a Web browser application program, and has acquired the Web page shown on screen 50. At an initial point in the run of the application program, the user is presented with dialog box 51 that prompts the user to select the complexity level at which computer generated service data is presented to the user.

Service data is intended to include data generated by service programs, i.e. all computer programs and routines that provide support to the application programs being run on the data processor or computer. Such service programming is often in the operating system or at times in the BIOS of the data processing system. However, in some service programming, such as help functions, at least a portion of the function may be in the running application program itself. Some typical service functions that may result in the display of service data to the user are error messaging, the labeling including icon representation of functions and help instructions. Conventionally, labels are terms, symbols, characters or icons. Since the service data presented to the user should include some labeling, the complexity of the labels displayed to the user should be determined by the selected complexity level. For example, the more complex item may use a short descriptive term because it may be assumed that the user does not require too much descriptive data to understand what is represented. On the other hand the description for the novice may include highly descriptive labels.

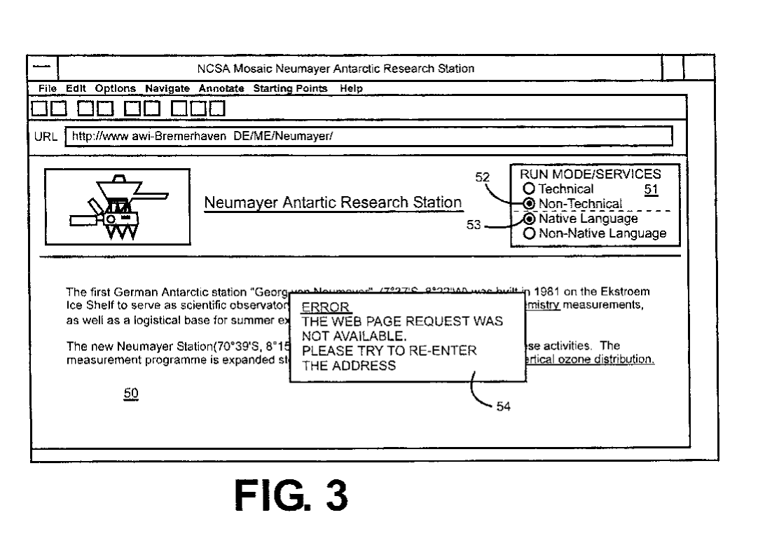

In any event, with respect to FIG. 2, the user is prompted to make two complexity level selections: one as technicality and the other as to language or text. In the present example, as indicated by the dotted selection circles, the user has selected a lower or non-technical level 52 of technicality, and a higher “native language” level 53 for text presentation. Based upon these selections, when, for example, an error message is to be generated as in FIG. 3, error message 54, the language level is relatively high but the technicality is simplified and low.

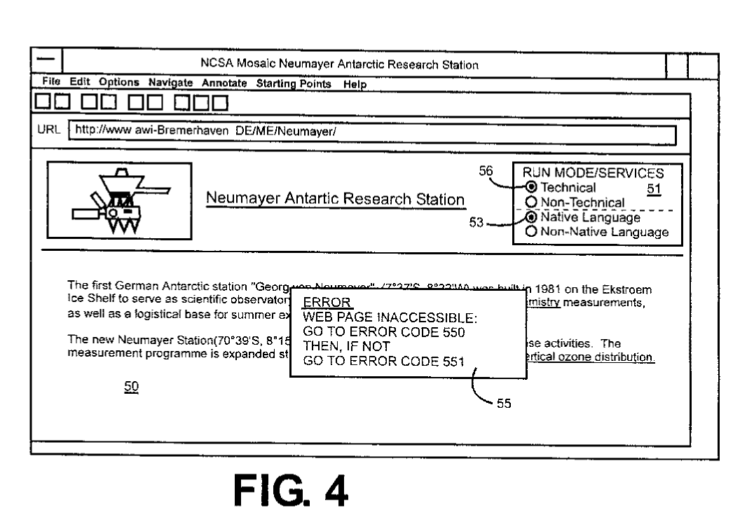

At any stage in the running of the application program, the complexity levels may be changed simply by interactively changing the selections in the dialog box 51. In FIG. 4, for example, the technicality selection has been interactively changed by the user so that the selected technicality is now “Technical” 53. This results in an error message 55 that is still at a good language level but is more technical:

“Web page inaccessible: Error Code 550 occurred, followed by Error Code 551”

While the illustration has shown only two complexity levels for each category, it should be understood that each category may offer the user several selections. For example, with respect to language, the user prompt may include the following categories:

Child (12-17)

Adult: Native Speaker

Adult: Non-Native Speaker

With respect to technicality, the user prompt may include the following categories:

Novice

Technician

Advanced Engineer

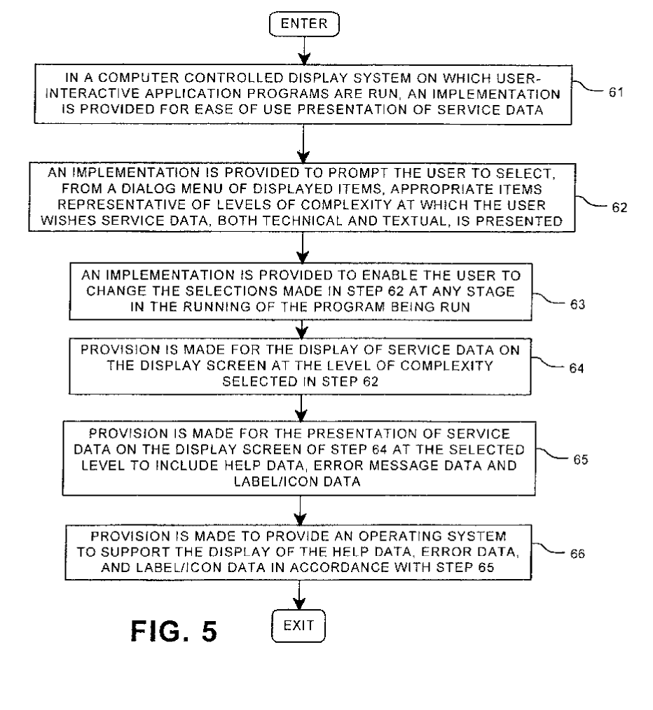

Now, with reference to FIG. 5, there will be described a process implemented by a program according to the present invention for presenting service data at a user selected complexity level during the running of application programs. Programming is provided for a computer controlled display system during the running of application programs to implement ease of use presentation of service data, step 61. An implementation is provided to prompt a user to select, from a dialog menu of displayed items that is displayed at an initial stage of the application program run, items representative of complexity levels at which the user wishes service data, both technical and textual, to be presented to the user during the course of the program run, step 62. An implementation is provided to enable the user to change the selections made in step 62 at any stage in the running of the application program, step 63. Provision is made, step 64, for the display of service data on the display screen at the level of complexity selected in step 62. Provision is made for the presentation of service data on the display screen of step 64 at the selected level to include help data, Error Message data, and Label/Icon data, step 65.

Finally, provision is made to provide an operating system to support the display of the Help data, Error Message data, and Label/Icon data in accordance with step 65. This requires the storage of a plurality of levels of the displayable items representative of the respective knowledge levels of the help data, Error Message data, and Label/Icon data functions. The creators of the operating systems or application programs providing these functions must anticipate the disparities in such knowledge levels to provide appropriate alternates. Of course, a great many of the items to be displayed will be simple enough so that the same item may be displayed for any selected knowledge level. However, many of the items will require the storage of a set of alternate items of varying complexity. In operation, the complexity level selected by the user will be stored. Then when an item is to be displayed, a determination is made as to whether there is only one item common to all levels. If so, then that item is displayed. On the other hand, if several alternate complexity levels are stored, the system will look to the user selected level and display the appropriate alternate item.

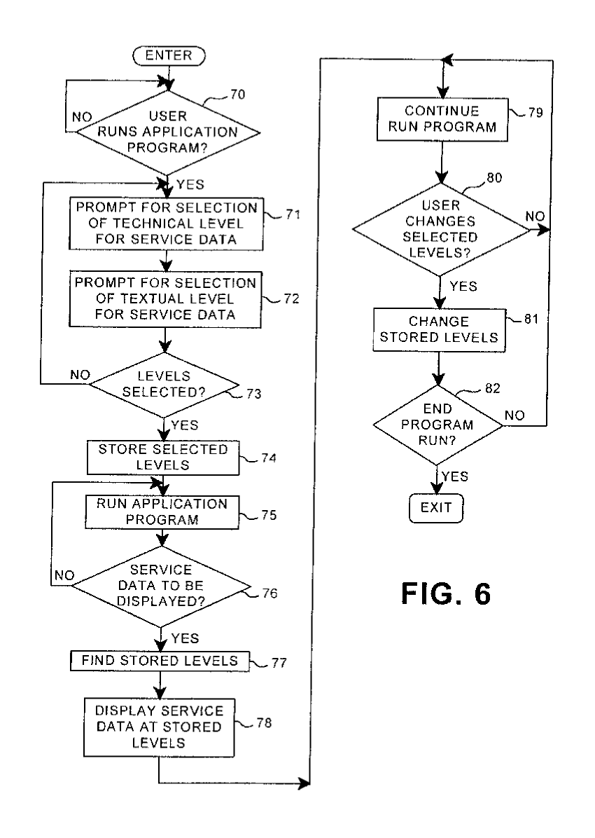

Now that the basic programs have been described and illustrated, there will be described with respect to FIG. 6 a flow of a simple operation showing how the program could be run to provide service data at a user selected complexity level during the running of application programs. In a computer operation, an initial determination is made as to when the interactive user starts to run an application program, step 70. If Yes, the user is prompted for the selection of a level of technical complexity for service data to be presented to the user during the running of the application program, 71. Provision may also be made to enable the user to change the complexity levels subsequent to installation. For example, even a novice user, after using an application program for awhile may acquire sufficient knowledge so that he may wish to change complexity levels in order to get the additional data provided at the higher complexity levels. In the case of heuristic systems wherein the system tracks and interprets user input, provision could be made based upon such input to prompt the user to change complexity levels where warranted.

With respect to the combination of the operating system and the application program each contributing functions determining the complexity levels, the operating system could provide default complexity levels that the application program could override where appropriate.

Then, the user is prompted for the selection of a textual or language level to be used for the presentation of service data during the run, step 72. A determination is made as to if the user in response to the prompt has selected levels, step 73. If Yes, the selected levels are stored, step 74, and the application program is run, step 75. Then, a determination is being continually made as to whether there is service data to be displayed, step 76. If No, the running of the application program is continued, step 75. If Yes, the stored complexity levels are located, step 77, and the appropriate service data is presented on the display screen at the selected levels, step 78. The program continues to be run, step 79. During this run, a determination is being continually made as to whether the user has changed selected levels of either text or technical service data to be presented, step 80. If No, the running of the application program is continued, step 79. If Yes, the levels are changed, step 81, and the application program continues to be run. At convenient stages, a determination is made as to whether the application program run is ended, step 82. If No, the process is branched back to step 79 and the running of the application program is continued. If Yes, the application program is exited.

While the embodiment has been described with respect to a personal computer, it will be understood that the invention would be applicable to other computer controlled devices that run application programs or equivalents, e.g. personal digital assistants, and even sophisticated wireless telephones among others that have GUIs.

In sophisticated help systems where help data was dynamically generated rather than stored, there could be a set up wherein the user would be prompted with an interactive displayed “reading” test to determine the knowledge level and the help data generated accordingly.

Also, in cases where the user has selected the highest level of complexity, the behavior of the help system could change so that there would be less simple “bubble messages” and new buttons could appear on the display screen to link the user to manuals for technical help.

While the invention has been shown and described with reference to particular embodiments thereof, it will be understood by those skilled in the art that the foregoing and other changes in form and detail may be made therein without departing from the spirit and scope of the invention.

What is claimed is:

1. In a computer controlled user interactive display system, a display interface implementation for the presentation of service data supporting user interactive application programs running on the system comprising:
means for offering to a user a plurality of selectable displayed items, each representative of a level of complexity at which service data is to be presented;
means enabling the user to select one of said complexity levels;
means for displaying user interactive application programs running on said system; and
means for presenting service data, relative to the program being run, at said selected complexity level.

2. The display system of claim 1 wherein at least a portion of said service data is provided from said application program.

3. The display system of claim 2 wherein said means for offering to a user a plurality of selectable displayed items, each representative of a level of complexity at which service data is to be presented include:
means in the operating system of said display system for offering to a user a default plurality of selectable displayed items, each representative of a level of complexity at which service data is to be presented; and
means in the application program for overriding items in said plurality of said selectable items or said levels of complexity at which service data is to be presented.

4. The display system of claim 1 further including means enabling the user to change any previously selected complexity level during the running of said application program.

5. The display system of claim 1 wherein said service data includes labels for the application program data being presented.

6. The display system of claim 1 wherein each complexity level corresponds to the technicality level by defining the terminology of the data presented.

7. A method of providing a display interface for the presentation of service data supporting user interactive application programs running on a computer controlled display system comprising:
offering to a user a plurality of selectable displayed items, each representative of a level of complexity at which service data is to be presented;
enabling the user to select one of said complexity levels;
displaying user interactive application programs running on said system; and
presenting service data, relative to the program being run, at said selected complexity level.

8. The method of claim 7 wherein at least a portion of said service data is provided from said application program.

9. The method of claim 8 wherein said step of offering to a user a plurality of selectable displayed items, each representative of a level of complexity at which service data is to be presented includes the steps of:
offering to a user, through the operating system of the display system, a default plurality of selectable displayed items, each representative of a level of complexity at which service data is to be presented; and
enabling the application program to override items in said plurality of said selectable items or said levels of complexity at which service data is to be presented.

10. The method of claim 7 further including the step of enabling the user to change any previously selected complexity level during the running of said application program.

11. The method of claim 7 wherein said service data includes labels for the application program data being presented.

12. The method of claim 7 wherein each complexity level corresponds to the technicality level by defining the terminology of the data presented.

13. The method of claim 7 wherein the complexity level is determined by the complexity of textual data presented.

14. A computer program having program code included on a computer readable medium for providing a display interface for the presentation of service data supporting user interactive application programs running on a computer controlled display system comprising:
means for offering to a user a plurality of selectable displayed items, each representative of a level of complexity at which service data is to be presented;
means enabling the user to select one of said complexity levels;
means for displaying user interactive application programs running on said system; and
means for presenting service data, relative to the program being run, at said selected complexity level.

15. The computer program of claim 14 wherein at least a portion of said service data is provided from said application program.

16. The computer program of claim 15 wherein said means for offering to a user a plurality of selectable displayed items, each representative of a level of complexity at which service data is to be presented include:
means in the operating system of said display system for offering to a user a default plurality of selectable displayed items, each representative of a level of complexity at which service data is to be presented; and
means in the application program for overriding items in said plurality of said selectable items or said levels of complexity at which service data is to be presented.

17. The computer program of claim 14 further including means enabling the user to change any previously selected complexity level during the running of said application program.

18. The computer program of claim 14 wherein said service data includes labels for the application program data being presented.

19. The computer program of claim 14 wherein each complexity level corresponds to the technicality level by defining the terminology of the data presented.

20. The computer program of claim 14 wherein the complexity level is determined by the complexity of textual data presented.
